(19) United States
(12) Patent Application Publication
(10) Pub. No.: US 2017/0011650 A1
(43) Pub. Date: Jan. 12, 2017

(54) SYSTEM FOR PROMOTING A SECURE PARENT/CHILD ATTACHMENT BOND

(71) Applicant: Simms/Mann Institute for Education and Community Developement, Beverly Hills, CA (US)

(72) Inventor: Victoria M. Simms, Beverly Hills, CA (US)

(21) Appl. No.: 15/272,121

(22) Filed: Sep. 21, 2016

Related U.S. Application Data
(63) Continuation-in-part of application No. 14/994,000, filed on Jan. 12, 2016.
(60) Provisional application No. 62/102,252, filed on Jan. 12, 2015.

(51) Int. Cl. G09B 19/00

(52) U.S. Cl. CPC G09B 19/00

(57) ABSTRACT

A system with a transitional object to promote the bond between children and adults by exchanging that object when in the absence or presence of the adult. Preferably the system is used between children and parents. The system has a first three-dimensional object, a second three-dimensional object that may be easily carried by an adult, wherein the first three-dimensional object receives the second three-dimensional object which is removably enclosed by the first three-dimensional object. When the parent and child are together the second three-dimensional object is enclosed by the first three-dimensional object, and when the parent leaves the child, the second three-dimensional object is removed and kept with the parent. Upon returning to the child the parent re-disposes the second three-dimensional object in association with the first three-dimensional object. This ritual and routine promotes bonding between an adult and child.

### CROSS REFERENCE TO RELATED APPLICATIONS/INCORPORATION BY REFERENCE STATEMENT

The present application is a continuation-in-part of U.S. Ser. No. 14/994,000, filed on Jan. 12, 2016, which claims priority to the provisional patent application identified by U.S. Ser. No. 62/102,252, filed on Jan. 12, 2015, the entire contents of all of which are hereby incorporated herein by reference in their entirety.

### BACKGROUND

Changing economic conditions have greatly increased the number of households where all the parents work outside of the home. Combined with the increasing 24/7 work culture, parents have less time they can spend with their children. So, stable and caring relationships that provide consistency and predictability between parents and children are more important than ever.

Most parents want to do everything possible to support their child's healthy development but feel stretched for time and baffled about where to begin. Among other things, parents want to provide their toddlers with opportunities for reciprocal social interactions. These early interpersonal exchanges, which researchers are calling “serve and return” have enormous impact on their babies' developing brain architecture. Neuroscience research now verifies that a child's early experiences set the stage for lifelong learning, behavior and health.

Distress at separation is a perfectly normal part of childhood and can start during infancy, toddlerhood or preschool. Initially, newborn children are totally dependent on their parents and see their parent(s) as an extension of them. Around four-months-old, children become more aware of their surroundings and begin to see their parent as a separate person. In fact, at this point children have difficulty understanding that their parents continue to exist when they cannot see them. Moreover, because children generally don't have a concept of time, they don't know if or when their parents will come back. This is true even if the parent is just in another room. This disappearance can make the children feel alone and disconnected from their parent, creating uncertainty, fear or anxiety.

Children have always found comfort in the familiar, soft touch of a security blanket, lovie or cuddly toy. These types of objects are referred to by researchers as transitional objects. In fact, people of all ages use transitional objects, from students taking their stuffed animal to college to heirlooms with special meaning that link us to past generations.

There is a need for a system that provides the benefit of a transitional object with further benefits to promote the bond between adults and children.

### SUMMARY OF THE INVENTION

In one aspect of the invention, a system for promoting a secure parent/child attachment bond is disclosed. The system includes a three-dimensional object, an article that may be worn or otherwise easily carried by an adult, wherein the three-dimensional object includes means for temporarily attaching the removable attachment to the three-dimensional object.

In another aspect of the invention, a system for promoting a secure parent/child attachment bond is disclosed. The system includes a three-dimensional object, an article that may be worn or otherwise easily carried by an adult, wherein the three-dimensional object includes means for temporarily attaching the removable attachment to the three-dimensional object, and a plurality of cards, wherein each card carries text that provides rituals, routines, and/or tips to promote parent-child bonding.

In another aspect of the invention, a method for creating a secure parent/child attachment bond is disclosed. The method includes providing a child with a three-dimensional object, wherein the three-dimensional object has an attachment means and an article attached to the three-dimensional object by the attachment means; removing the article attached to the three-dimensional object by the attachment means when a parent separates from the child; attaching the article to the parent when the parent separates from the child; and re-attaching the article by the attachment means to the three-dimensional object at the time the parent returns to the child.

### BRIEF DESCRIPTION OF THE DRAWINGS

FIG. 1 is a front perspective view of an embodiment of the present invention.

FIG. 2 is a front perspective view of FIG. 1 without the three-dimensional object.

FIG. 3 is a perspective of an embodiment of the removable attachment.

FIG. 4 is a side view of another embodiment of the present invention.

FIG. 5 is a side view of another embodiment of the present invention.

FIG. 6 is a front perspective view of another embodiment of the present invention.

FIG. 7 is a front perspective of an embodiment of the three-dimensional object.

FIG. 8 is a demonstrative of a use of the three-dimensional object and removable attachment between a child and a parent.

FIG. 9 is a perspective view of another embodiment of a three-dimensional object shown in a closed position.

FIG. 10 is a perspective view of the three-dimensional object of FIG. 9 shown in an open position to expose an opening in the three-dimensional object.

FIG. 11 is a perspective view of the three-dimensional object of FIG. 9 shown with a second three-dimensional object disposed in the opening.

FIG. 12 is a perspective view of the three-dimensional object of FIG. 11 shown in a closed position and enclosing the second three-dimensional object.

FIG. 13 is a sectional view taken along the 13-13 line of FIG. 12.

FIG. 14 is a sectional view taken along the 14-14 line of FIG. 12.

FIG. 15 is a front perspective view of the second three-dimensional object of FIG. 20 shown attached to another three-dimensional object.

FIG. 16 is a side view of another embodiment of the present invention.

FIG. 17 is a side view of another embodiment of the present invention.

The foregoing figures are potential illustrations of a three-dimensional object and removable attachment, using in particular the example of a lovie (with an animal head) and bracelet. The foregoing figures are also potential illustrations of a three-dimensional object that may be removably enclosed by another three-dimensional object, using in particular the example of a heart-shaped object and a book. It should be understood by those skilled in the art that these figures do not limit the associated disclosures but merely exemplify them.

### DETAILED DESCRIPTION OF THE INVENTION

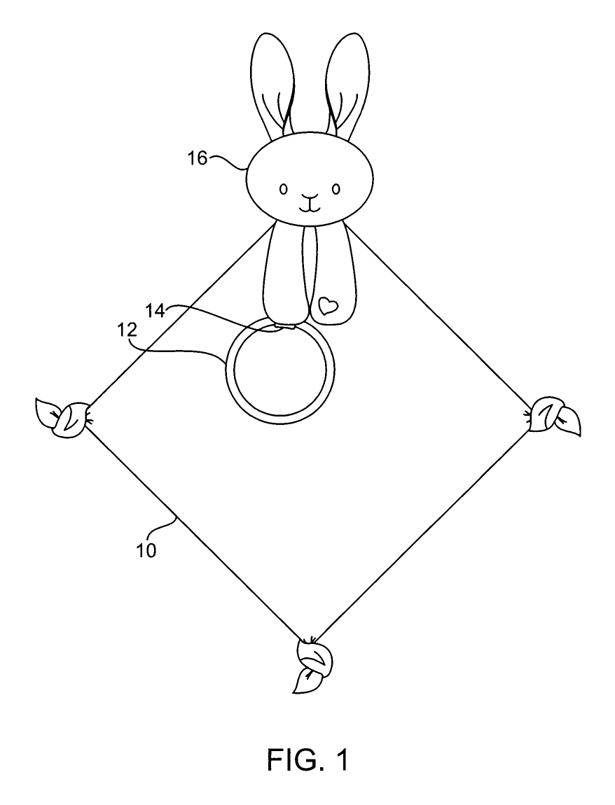

As shown in FIG. 1, generally, the invention is a system that comprises a three-dimensional object 10 that is also preferably capable of absorbing the scent of a human and a removable attachment 12 that may be worn or otherwise easily carried by an adult.

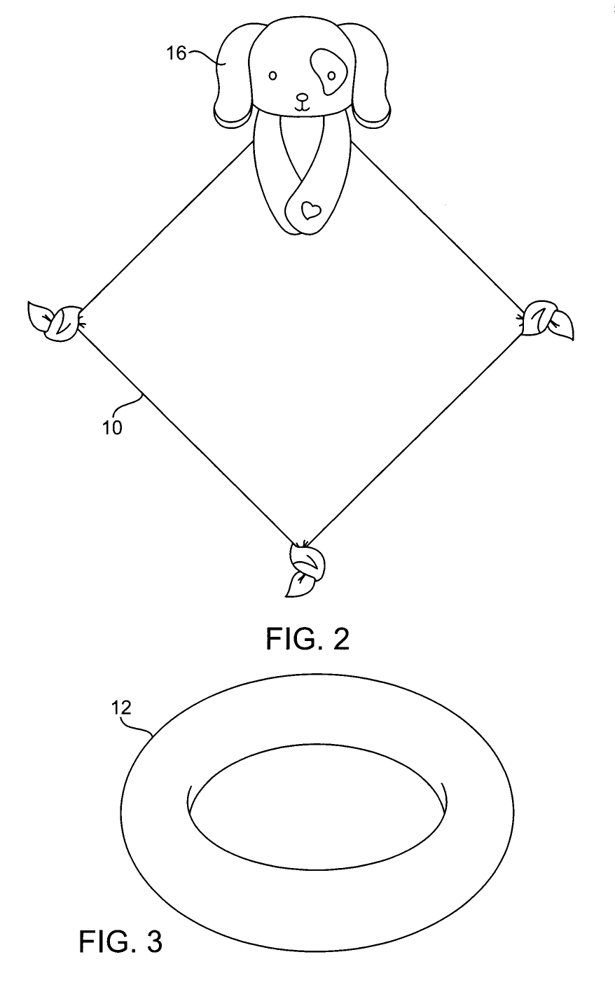

As shown in FIG. 2, the three-dimensional object 10 is preferably soft and may be, among other possibilities, a blanket, lovie, swaddle, plush or semi-plush toy. Alternatively, it is envisioned that the three-dimensional object may be semi-soft, such as a book, a rattle, a ball, or any other semi-soft baby-related item. It is also envisioned that a rigid three-dimensional object may also be utilized.

The removable attachment 12 may be, among other possibilities, a bracelet, pendent, ring, pin, teething toy, pacifier, bracelet that functions as a teething toy, or tie clip. In any event, the removable attachment 12 should be constructed from material that is safe for children to place in their mouths, such as a 100% (BPA free) silicone. The removable attachment 12 can be configured in any shape as long as it is configured in a manner in which children will not swallow the removable attachment 12 or otherwise injure themselves. Most preferably, the removable attachment 12 is a bracelet. As shown in FIG. 3, in instances where the removable attachment 12 is a bracelet, it is preferably round, but may be in alternative shapes, including, but not limited to square or hexagonal. The bracelet 12 also preferably has rounded edges, but may also have non-rounded edges.

As shown in FIGS. 1, and 4-6, in one embodiment the system the three-dimensional object 10 is a lovie with an animal head 16 and the removable attachment 12 is a bracelet. The animal head 16 may be any animal including, but not limited to a dog, a duck, a dinosaur, a monkey, a cat, a lion, a tiger, a penguin, a rabbit, and an elephant. It is contemplated that the head 16 could be a licensed character (e.g. Mickey Mouse, Elmo, and Hello Kitty), in an embodiment, for example, where the three-dimensional object 10 is intended for use with an older child.

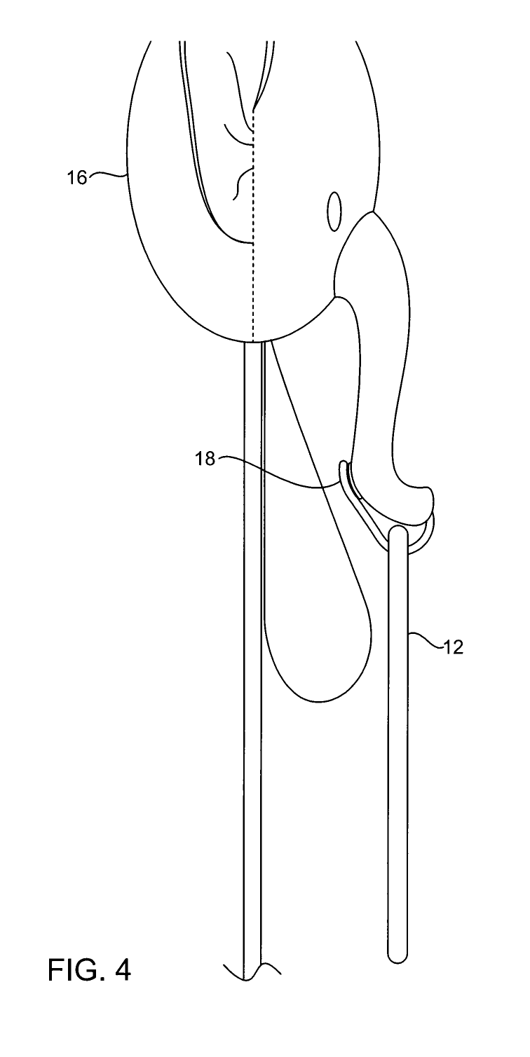

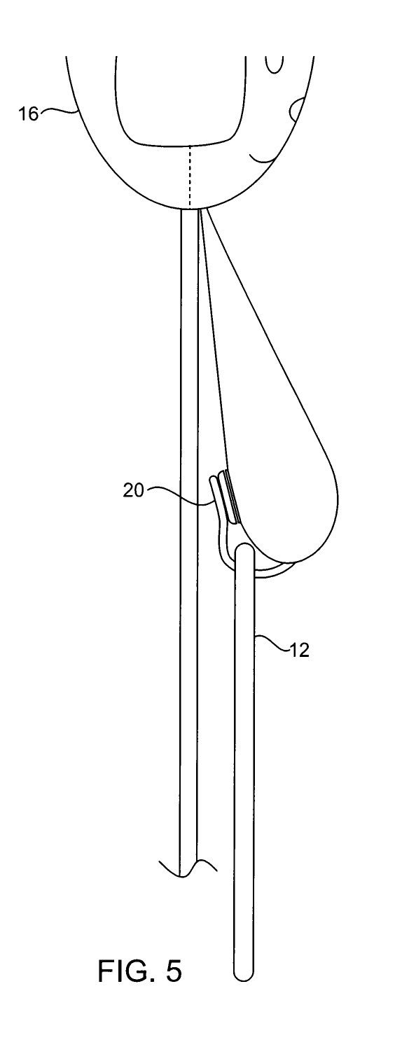

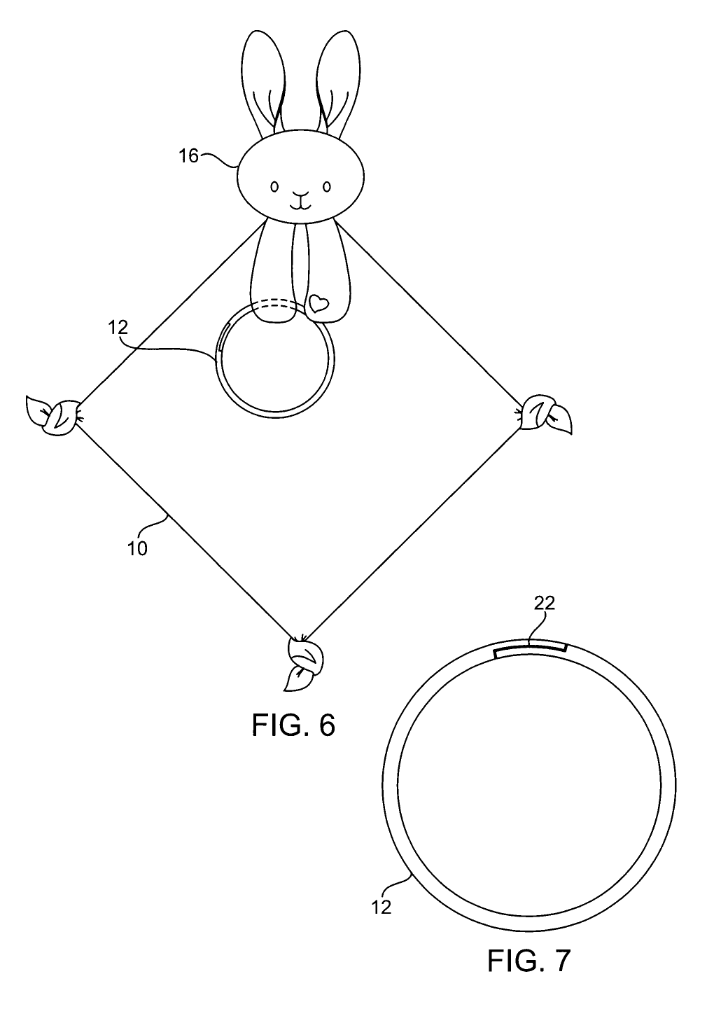

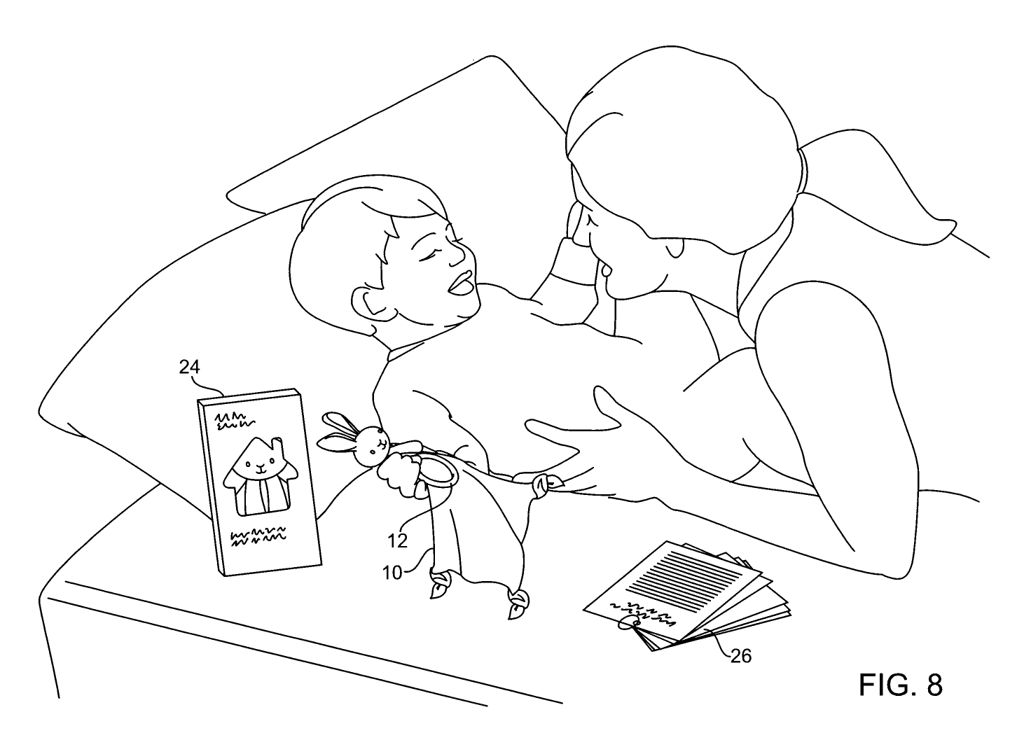

As shown in FIGS. 4-6, the three-dimensional object 10 may have means for temporarily attaching 14 the removable attachment 12. As shown in FIGS. 4-5, the removable attachment 12 may be accomplished by through different means. As shown in FIG. 4, of a loop of material (e.g. fabric) that is long enough to wrap around the removable attachment 12 and be temporarily closed by way of a hook and loop fastener pair 18 (such as a Velcro®-brand fastener). Alternatively, as shown in FIG. 5, the fastener may be a snap 20 (preferably plastic). Alternatively, the fastener may be a button-buttonhole combination, or it is envisioned that any fastener that is child appropriate may be used. Where the three-dimensional object 10 is formed of fabric, it would be possible for the removable attachment 12 to be removably attached by simply tying a knot in the three-dimensional object 10 around the removable attachment 12. Alternatively, as shown in FIGS. 6 and 7, the removable attachment 12 may be a separable means 22 that will allow the removable attachment 12 to attach to the three-dimensional object 10.

The system may also include a second removable attachment 12, such that in two parent families, both parents may have a removable attachment 12. In such systems the means for temporarily attaching the removable attachment 12 may accommodate both articles.

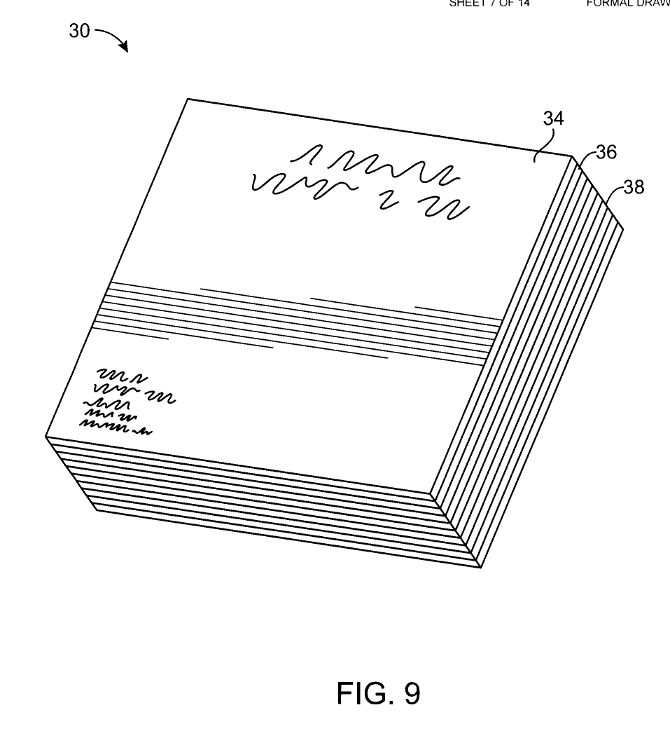

As shown in FIG. 8, the system may also include cards 26 carrying text that provides rituals, routines, and/or tips to promote parent-child bonding. As shown in FIG. 8, the cards 26 are preferably bound together by some sort of binding means, such as a ring 28, or any other type of binding that will hold the cards together. The binding should preferably be made with child safe materials. Alternatively, the cards may be stored individually, or stored within a package. The cards 26 should be made of a sturdy material and of a thickness which makes them difficult to be destroyed (torn, ripped, chewed) if handled by a child. Preferably the cards 26 are made of cardboard, but other materials are also envisioned, including, but not limited to plastic and wood. Also, preferably the cards 26 are rectangular shaped, but other configurations are envisioned.

As shown in FIG. 8, the invention preferably also includes a package (or box) 24 to store the three-dimensional object 10, the removable attachment 12, and the cards 26. The package 24 should preferably be made with child safe materials and configured to hold the three-dimensional object 10, the removable attachment 12, the cards 26 and/or parent-child keepsakes. These parent-child keepsakes may include photos and any other meaningful items that may be used by the child to calm themselves during the absence of the parent. The parent may also use the package 24 to leave surprise messages and/or gifts to the child. The package 24 should be made of a sturdy material and of a thickness which makes it difficult to be destroyed (torn, ripped, chewed) if handled by a child. Preferably the package 24 is made of thick cardboard, but other materials are also envisioned, including, but not limited to plastic and wood. Preferably the package 24 is a box, but other configurations are envisioned, including, but not limited to tubes and bags.

As shown in FIG. 8, the adult would use the three-dimensional object 10 with the child throughout the day, day-after-day, particularly as part of the child's routines and rituals with the parent. The continued use and close physical connection between the parent, three-dimensional object 10, and the child will allow the child to associate the three-dimensional object 10 with his or her parent and—where so configured—will result in the parent's scent transferring onto the soft three-dimensional object 10. For instance, the soft three-dimensional object 10 may be used by the parent in snuggling, feeding, while reading stories and/or playing games with the child.

Focusing on the example where the three-dimensional object 10 is a soft or semi-soft object, such as a lovie, one potential game using the lovie embodiment, would be a traditional game of “peek-a-boo.” As shown in FIGS. 1 and 2, where the soft, three-dimensional object 10 is a lovie, inclusion of a friendly animal character of the lovie would be designed for optimal appeal. However, even babies have preferences. So, the system may include alternative lovies and/or replacement animal character attachments for the existing blanket portion of the lovie to allow parents to modify the object to the child's preferences.

Where the three-dimensional object 10 is a rigid object, the described use rituals and routines would be the same, but the parent's scent would not be transferred.

As shown in FIG. 8, when the adult and child are together, the removable attachment 12 is preferably removably attached to the three-dimensional object 10.

The three-dimensional object 10 and removable attachment 12 may preferably be used to conduct “bye bye” and “hello” rituals between parent and child. These rituals would preferably involve calm quiet time focused on the relationship between parent and child and further include the physical disconnection/connection between three-dimensional object 10 and removable attachment 12. Upon disconnecting the removable attachment 12 from the three-dimensional object 10, the parent may tell the child that when the parent misses the child during their time apart, the parent will touch the removable attachment 12 and think of the child and that the child should do the same with the three-dimensional object 10. When the parent returns home, the parent greets the child and physically reconnects the removable attachment 12 to the three-dimensional object 10 and preferably spends one-on-one time with the child of at least a few minutes.

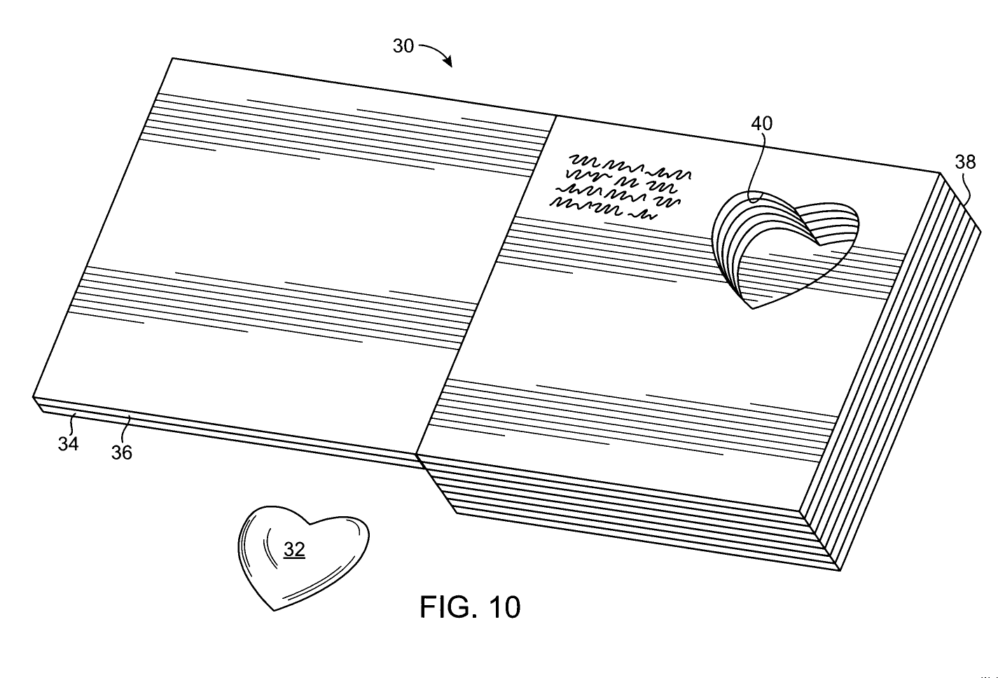

Referring now to FIGS. 9-14, another embodiment of a system designed in accordance with the inventive concepts disclosed herein is illustrated. As shown in FIGS. 9-10, the system includes a first three-dimensional object 30 and a second three-dimensional object 32.

As shown in FIG. 9, the first three-dimensional object 30 may be a book. Similar to three-dimensional object 10, the first three-dimensional object 30 may be constructed of a rigid material. As such, as shown in FIG. 9, the first three-dimensional object 30 may be a board book. In FIG. 9, the board book is shown in a closed position. The board book includes a cover page 34, a first page 36, and remaining pages 38. It should be appreciated (particularly in view of the various embodiments disclosed) that the first three-dimensional object 30 may be any object suitable for use with young children. In addition to the possibility of different types of objects, the first three-dimensional object 30 may also be soft or semi-soft, instead of rigid. For instance, a book made of a soft material, including, but not limited to, polyester, or some other semi-soft baby-related item capable of absorbing the scent of a human could be used to form the first three-dimensional object 30.

As shown in FIG. 10, the second three-dimensional object 32 may be a heart-shaped object. It should be appreciated by those having the present specification, drawings, and claims before them that the second three-dimensional object 32 may be configured in any shape so long as it is configured in a manner in which a young child will not be able to swallow the second three-dimensional object 32 or otherwise injure him or herself with the second three-dimensional object 32. For example, the second three-dimensional object 32 may be shaped as a star, a flower, a toy ball, a crescent moon, or any other shape known to be pleasing to the eye of and safe for a child. In any event, the second three-dimensional object 32 should be constructed from a material that is safe for a child to place in his or her mouth, such as 100% (BPA free) silicone.

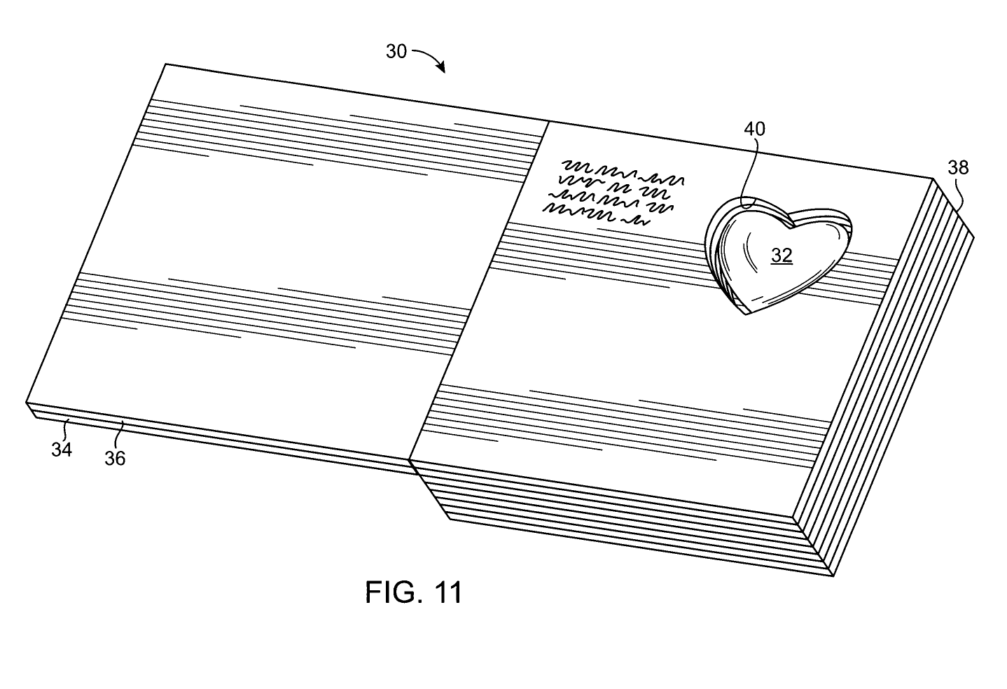

The first three-dimensional object 30 is shown in an open position in FIGS. 10-11, which show that first three-dimensional object 30 may include an opening or well 40 for removably receiving the second three-dimensional object 32 therein. The opening 40 may be sized and shaped to substantially correspond to the size and shape of the second three-dimensional object 32, except that the size of the opening 40 may be slightly larger than the size of the second three-dimensional object 32. For example, in the embodiment where the second three-dimensional object 32 is a heart-shaped object, the opening 40 may also be heart-shaped and sized slightly larger than the heart-shaped object, as shown in FIGS. 10-11. Alternatively, in an embodiment where the second three-dimensional object 32 is constructed of another shape, such as, but not limited to, a star or a flower, then a corresponding opening would be constructed of a size and shape to receive any alternatively shaped second three-dimensional object.

As shown in FIG. 11, the second three-dimensional object 32 may be removably disposed in the opening 40 such that the second three-dimensional object 32 is at least partially removably enclosed by the first three-dimensional object 30. In the embodiment where the three-dimensional object 30 is book, a portion of the remaining pages 38 includes the opening 40 such that the front cover 34 may be opened to expose the opening 40 and may be closed to removably enclose the second three-dimensional object 32 substantially within the opening 40. As shown in FIGS. 10-11, the opening 40 may not be exposed until the front cover 34 and the second page 36 are opened. In fact, the opening 40 may be hidden from view by any number of pages so long as the portion of the remaining pages 38 containing the opening 40 is sized to receive substantially the full thickness of the second three-dimensional object 32. Again, it should be appreciated that the first three-dimensional object 30 may be any object suitable for young children that may removably receive and removably enclose the second three-dimensional object 32, which may also be any object suitable for young children.

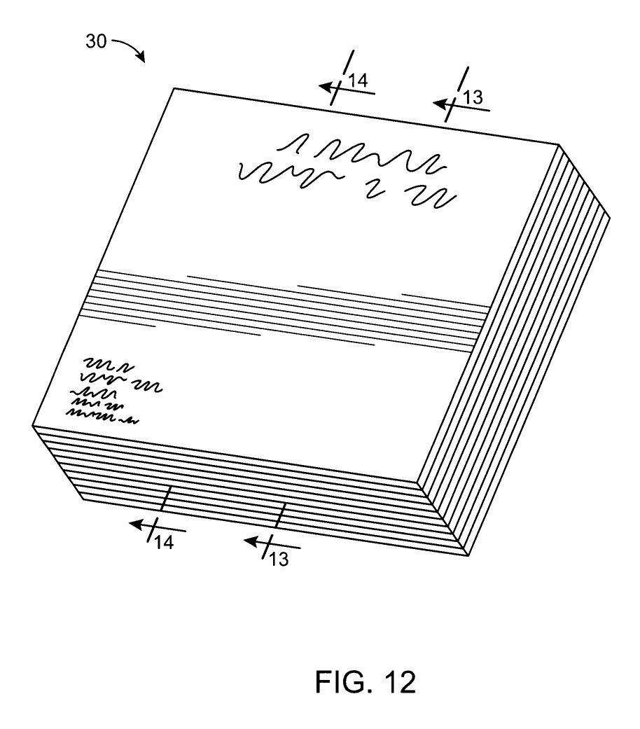

As shown in FIG. 12, the second three-dimensional object 32 may be removably enclosed by the first three-dimensional object 30 such that the second three-dimensional object 32 is stored and hidden from view. In this way, the first three-dimensional object 30 resembles a traditional closed book with an unsuspecting object enclosed inside it.

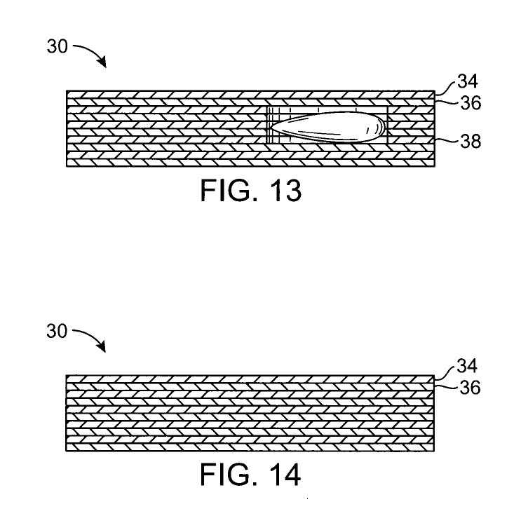

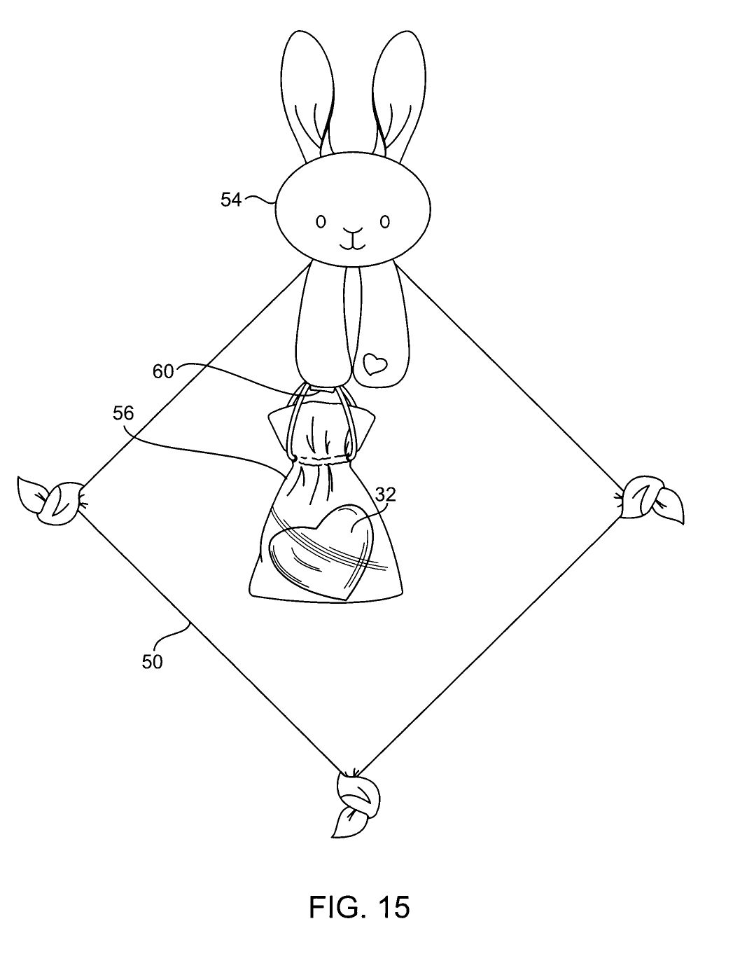

As shown in FIG. 13, a portion of the remaining pages 38 includes the opening 40 such that the second three-dimensional object 32 is removably enclosed by the first three-dimensional object 30 when the front cover 34 and the first page 36 are closed. The height of the second three-dimensional object 32 is less than the depth of the opening 40 such that the front cover 34, the first page 36, and the remaining pages 38 lie flush upon one another when the first three-dimensional object 30 is in the closed position, as shown in FIG. 14.

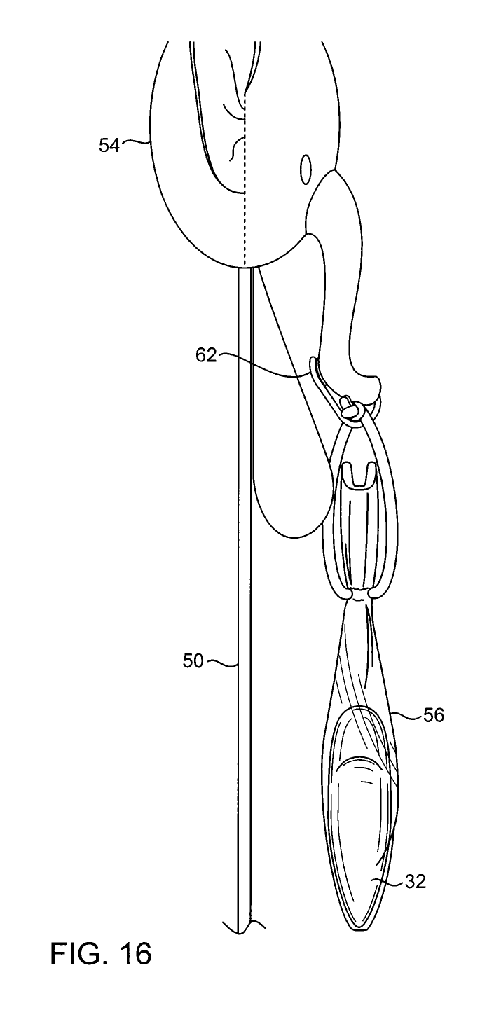

As shown in FIGS. 15-17, in still another embodiment of the system, the system may comprise a third three-dimensional object 50. The third three-dimensional object 50 may include a means 60 for temporarily attaching the second three-dimensional object 32 to the third three-dimensional object 50. The means 60 may include a bag or other container capable of holding the second three-dimensional object 32 and which is formed of material for safe handling by a child.

As shown in FIG. 15, in one embodiment the third three-dimensional object 50 is a lovie with an animal head 54 and the second three-dimensional object 32 is a heart-shaped object removably disposed in a drawstring pouch 56 extending from the lovie head 54, which comprises one embodiment of a means for temporarily attaching the second three-dimensional object 32 to another three-dimensional object, such as the third three-dimensional object 50.

The third three-dimensional object 50 may be constructed substantially like the three dimensional objects described above. For example, the third three-dimensional object 50 is preferably soft and may be, among other possibilities, a blanket, lovie, swaddle, plush or semi-plush toy. The animal head 54 may be constructed substantially similar to the animal head 16 and may be any animal including, but not limited to a dog, a duck, a dinosaur, a monkey, a cat, a lion, a tiger, a penguin, a rabbit, and an elephant. The pouch 56 may be made of at least a semi-translucent material so as to reveal the heart-shaped object disposed in the pouch 56.

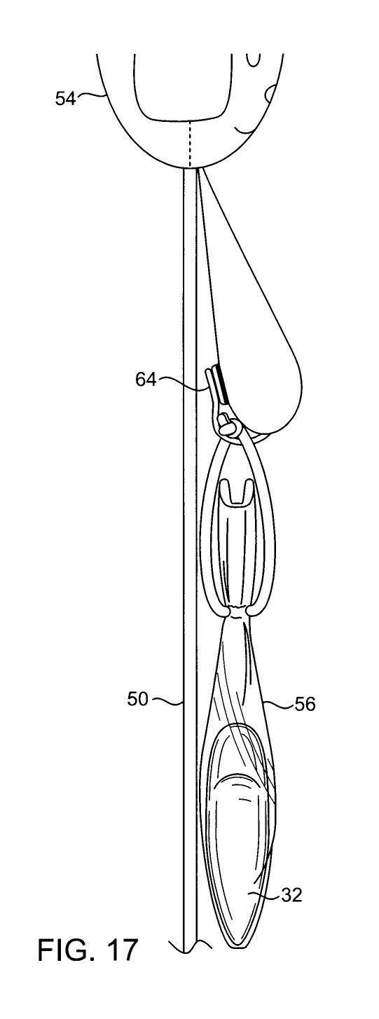

As shown in FIGS. 16-17, the second three-dimensional object 32 may attached to the third three-dimensional object 50 by different means. As shown in FIG. 16, a loop of material (e.g. fabric) that is long enough to wrap around a loop of the drawstring bag may be temporarily closed by way of a hook and loop fastener pair 62 (such as a Velcro®-brand fastener). Alternatively, as shown in FIG. 17, the fastener may be a snap 64 (preferably plastic). Alternatively, the fastener may be a button-buttonhole combination, or it is envisioned that any fastener that is child appropriate may be used.

It is also envisioned that the second three-dimensional object 32 may include a hole through which a portion of the third three-dimensional object 50 may be inserted for attaching the second three-dimensional object 32 to the third three-dimensional object 50, which may comprise another embodiment of the means for temporarily attaching the second three-dimensional object 32 to another three-dimensional object. For example, a loop of material, such as the loop of material shown in FIG. 16, may be inserted through the hole in the second three-dimensional object 32 and may be temporarily closed by way of a fastener, such as the hook and fastener pair 62 (shown in FIG. 16) or a snap 64 (shown in FIG. 17). In an embodiment where the second three-dimensional object 32 is a heart-shaped object, some of those in the art might view the inclusion of a hole in the second three-dimensional object 32 as less desirable because of the possible psychological impact associated with a heart-shaped object having a hole in it. Accordingly, a snap receiving grommet may be integrated into the second three-dimensional object to avoid the introduction of a hole. With this approach, a snap may be provided on the third three-dimensional object 50 that operably connects to the grommet to create a temporary physical attachment between the second and third three-dimensional objects.

Similar to the three-dimensional object 10 and the removable attachment 12, the first three-dimensional object 30 and the second three-dimensional object 32 may be used to conduct “bye bye” and “hello” rituals between parent and child. In the embodiment where the first three-dimensional object 30 is a book, these rituals would preferably involve calm quiet time during which the parent and child read the book together. The continued use and close physical connection between the parent, the first three-dimensional object 30, and the child will allow the child to associate the first three-dimensional object 30 with his or her parent or other caregiver. Upon removing the second three-dimensional object 32 from the opening 40 of the first three-dimensional object 30, the parent may tell the child that when the parent misses the child during their time apart, the parent will touch the second three-dimensional object 32 and think of the child and that the child should do the same with the three-dimensional object 10. When the parent returns home, the parent greets the child and disposes the second three-dimensional object 32 in the opening 40 of the first three-dimensional object 30 and preferably spends one-on-one time with the child for at least a few minutes.

Alternatively, the parent may attach the second three-dimensional object 32 on the third three-dimensional object 50 by a means, such as means 60, and engage in a substantially similar “bye bye” and “hello” ritual as described with respect to the three dimensional object 10.

It is further envisioned that a fourth three-dimensional object may be temporarily attached to the third three-dimensional object 50 by way of a means, such as, but not limited to, means 60. For example, a bracelet, pacifier, teething toy, a bracelet that functions as a teething toy, or any other three-dimensional object suitable and safe for handling by an infant or child may be temporarily attached to the three-dimensional object 50. The fourth three-dimensional object may be used in addition to the paired three-dimensional objects discussed above. By way of example only, a parent may temporarily attach the second three-dimensional object 32 (such as a heart-shaped object) to the third three-dimensional object 50 while the parent and child are together and then attach the fourth three-dimensional object, such as, but not limited to, a teething toy, to the three-dimensional object 50 while the parent and child are apart from one another. In another example, a parent may attach the fourth three-dimensional object, such as, but not limited to, a bracelet that functions as a teething toy, to the third three-dimensional object 50 when together with the child and then remove the fourth three-dimensional from the third three-dimensional object 50 and wear it on his or her wrist when apart from the child.

With each of the foregoing embodiments, the paired three-dimensional objects serve as psychological symbols to both parent (or other caregiver) and child. The objects are joined together when the child and parent are physically together and then the objects are subsequently separated as part of a daily ritual that essentially ends with the child taking one part of the overall object and the parent the other part of the overall object. In this way, each of the pieces provides a physical manifestation of the emotional connection between parent and child when they are apart and then subsequently come back together. The objects also provide a mechanism to better ensure a daily routine is established between child and parent that transitions parent and child into their separated state and subsequently transitions back from separation to togetherness. The symbolism of the objects and their interconnectedness helps make the concept of serve and return tangible for parent and child. Moreover, each object may help minimize the stress of physical separation by providing a token to hold onto the feeling of togetherness and the promise of rejoining.

The foregoing description merely explains and illustrates the invention without limiting the invention thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A system for promoting a secure parent/child attachment bond comprising:
a first three-dimensional object;
a second three-dimensional object that may be easily carried by an adult; and
wherein the first three-dimensional object removably receives the second three-dimensional object and the second three-dimensional object is at least partially removably enclosed by the first three-dimensional object when the second three-dimensional object is disposed in association with the first three-dimensional object.

2. The system of claim 1 further including means for guiding a user of the system to associate the physical receipt of the second three-dimensional object within the first three-dimensional object with the user physically returning to a child through use of a ritual emphasizing the transition.

3. The system of claim 1 wherein the first three-dimensional object is made of rigid material.

4. The system of claim 1 or 2 wherein the first three-dimensional object is a book.

5. The system of claim 1 further including a third three-dimensional object having a means for temporarily attaching the second three-dimensional object to the third three-dimensional object.

6. The system of claim 5 further including a fourth three-dimensional object that may be easily carried by an adult, wherein the third three-dimensional object has a means for temporarily attaching the fourth three-dimensional object to the third-three dimensional object.

7. The system of claim 6, wherein the fourth three-dimensional object is a three-dimensional object selected from the group consisting of a bracelet, a teething toy, a bracelet that functions as a teething toy, and a pacifier.

8. The system of claim 5 wherein the means for temporarily attaching the second three-dimension object is a bag.

9. The system of claim 5 wherein the third three-dimensional object is capable of absorbing the scent of a human.

10. The system of claim 5 wherein the third three-dimensional object is made of soft material.

11. The system of claim 5 wherein the third three-dimensional object is a lovie.

12. A method for creating a secure parent/child attachment bond comprising:
providing a child with a first three-dimensional object;
removably receiving within the first three-dimensional object a second three-dimensional object;
removing the second three-dimensional object from the first three-dimensional object when at least one parent separates from the child;
providing the second three-dimensional object to the parent when the parent separates from the child; and
disposing the second three-dimensional object within the first three-dimensional object at the time the parent returns to the child.
